(19) United States
(12) Patent Application Publication
(10) Pub. No.: US 2013/0340798 A1
(43) Pub. Date: Dec. 26, 2013

(54) INTEGRATED CLEANING IMPLEMENTS AND DISPENSATION DEVICES

(71) Applicant: L&F Innoventions, LLC, Naples, FL (US)

(72) Inventor: Thomas Perelli, Raleigh, NC (US)

(21) Appl. No.: 13/925,223

(22) Filed: Jun. 24, 2013

Related U.S. Application Data
(60) Provisional application No. 61/663,051, filed on Jun. 22, 2012.

(51) Int. Cl. B08B 3/04

(52) U.S. Cl. CPC B08B 3/04
USPC 134/198

(57) ABSTRACT

A cleaning system includes an elongate pole, a mounting structure, a cradle, and a spray bottle. The elongate pole has a proximal end for manipulation by a user and a distal end opposite the proximal end. The mounting structure is attached to the distal end of the pole for connecting a mopping implement to the distal end of the pole. The cradle is attached to the pole between the proximal end and the distal end. The spray bottle includes a spray head, an operable trigger, and a container housing defining an internal reservoir space. The container housing is removably received by the cradle. A flat mop can be connected to the mounting structure.

### CROSS-REFERENCE TO RELATED APPLICATION

This patent application claims the benefit of priority of U.S. Provisional Patent Application No. 61/663,051, filed on Jun. 22, 2012, and entitled “Spray Bottle Apparatuses and Associated Accessories.” The above-referenced provisional patent application is incorporated herein in entirety by this reference.

### TECHNICAL FIELD

This disclosure relates generally to janitorial-related products and services, and more particularly to spray devices consolidated with or mounted on handles of cleaning tools.

### BACKGROUND

Conventional spray bottles are used for mobile cleaning chores in conjunction with mops. For example, spot mopping sometimes refers to quick damp mopping at spill locations along floors and where other incidents of surface contaminations have occurred. In such scenarios, for example where workers or shoppers are present, a quick and yet thorough cleaning response is wanted. A person sent to attend to an incident may be multi-tasking or may otherwise not have both hands available for carrying cleaning equipment to a task location. Currently available examples of equipment consolidating cleaning implements and liquid cleaning supplies are typically bulky in size and weight. For example, wheeled assemblies having buckets and mounted mop wringers are available. While such assemblies have their uses, a more nimble response may be preferred in some scenarios. For example, a custodian cleaning a food court in a mall may have little room to move a wheeled mop bucket and wringer assembly between tables.

### SUMMARY

This Summary is provided to introduce a selection of concepts in a simplified form that are further described below in the Detailed Descriptions. This Summary is not intended to identify key features or essential features of the claimed subject matter, nor is it to be construed as limiting the scope of the claimed subject matter.

According to at least one embodiment, a cleaning system includes an elongate pole, a mounting structure, a cradle, and a spray bottle. The elongate pole has a proximal end for manipulation by a user and a distal end opposite the proximal end. The mounting structure is attached to the distal end of the pole for connecting a mopping implement to the distal end of the pole. The cradle is attached to the pole between the proximal end and the distal end. The spray bottle includes a spray head, an operable trigger, and a container housing defining an internal reservoir space. The container housing is removably received by the cradle. A flat mop can be connected to the mounting structure.

In at least one example, the mounted dispensing device includes an inlet port, and the container housing of the spray bottle includes an outlet port that mates with the inlet port of the mounted dispensing device when the spray bottle is received by the cradle. The outlet port may be recessed at least partially into a portion of the container housing.

In at least on example, a second operable trigger is mounted on the pole and dispensation from the internal reservoir space through the mounted dispensing device is prompted by actuation of the second operable trigger. Dispensation from the internal reservoir space through the spray head of the spray bottle may be prompted by actuation of the operable trigger of the spray bottle.

According to at least one embodiment, a cleaning system includes an elongate pole, a mounting structure, a fluid storage and dispensing apparatus, and a separable spray bottle. The elongate pole has a proximal end for manipulation by a user and a distal end opposite the proximal end. The mounting structure attaches to the distal end of the pole for connecting a mopping implement to the distal end of the pole. The fluid storage and dispensing apparatus mounts on an intermediate portion of the pole, the fluid storage and dispensing apparatus including a major housing having a receptacle, an internal on-board reservoir, and an on-board dispensation nozzle. The separable spray bottle includes a spray head, a trigger, and a container that can be removably received by the receptacle.

In at least one example, the spray bottle includes an outlet port, the major housing includes an inlet port positioned in the receptacle, and the outlet port of the spray bottle mates with the inlet port of the major housing upon insertion of the container into the receptacle. The container of the spray bottle extends the total volume available to the on-board dispensation nozzle to include both the internal on-board reservoir and the container of the spray bottle.

In at least one example, the container of the spray bottle and the on-board reservoir are linearly aligned when the container is received by the receptacle. The container of the spray bottle may have a columnar form that fits within a columnar space defined by the major housing.

In at least one example, the on-board reservoir is defined by an expandable bladder positioned within a rigid chamber defined by the major housing. The expandable bladder may include elastomeric material.

In at least one example, the spray bottle includes an inlet port for filling the container, and the fluid storage and dispensing apparatus includes an exterior fill port for filling the on-board reservoir. A refilling assembly for use in filling both the container of the spray bottle and the on-board reservoir includes a tank and a refilling head extending from the tank. The refilling head includes two couplings separated by a spacing that matches a spacing between the inlet port of the spray bottle and the exterior fill port. The refilling head may extend from the tank on a flexible conduit. In at least one example, the two couplings extend parallel to each other to permit simultaneous coupling with the inlet port of the spray bottle and the exterior fill port from a single angle of approach.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed.

FIG. 1A is a side elevation view of a cleaning system according to at least one embodiment.

FIG. 1B is a perspective view of the cleaning system of FIG. 1A

FIG. 1C is a perspective view of a separable spray bottle of the cleaning system of FIG. 1A.

FIG. 2A is a side elevation view of a cleaning system according to at least one other embodiment.

FIG. 2B is a closer side view of the cradle and spray bottle of the cleaning system of FIG. 2A.

FIG. 2C is a side elevation view of an embodiment of a spray bottle for use, in at least one example, with the cleaning system of FIG. 2A.

FIG. 3A is a side elevation view of a cleaning system according to at least one embodiment.

FIG. 3B is a side elevation view of an embodiment of a spray bottle for use, in at least one example, with the cleaning system of FIG. 3A.

FIG. 3C is a side elevation view of the cleaning system of FIG. 3A with the spray bottle of FIG. 3B mounted in a receptacle.

FIG. 3D is a view of exemplary internal components of the cleaning system and spray bottle of FIG. 3C.

FIG. 4A is a side view of a refilling assembly according to at least one embodiment.

FIG. 4B is a side view of the refilling assembly of FIG. 4A coupled to the cleaning system and spray bottle of FIG. 3C.

### DETAILED DESCRIPTIONS

While the disclosure of the technology herein is presented with sufficient details to enable one skilled in this art to practice the invention, it is not intended to limit the scope of the disclosed technology. The inventor(s) contemplate that future technologies may facilitate additional embodiments of the presently disclosed subject matter as claimed herein. Moreover, although the term “step” may be used herein to connote different aspects of methods employed, the term should not be interpreted as implying any particular order among or between various steps herein disclosed unless and except when the order of individual steps is explicitly described.

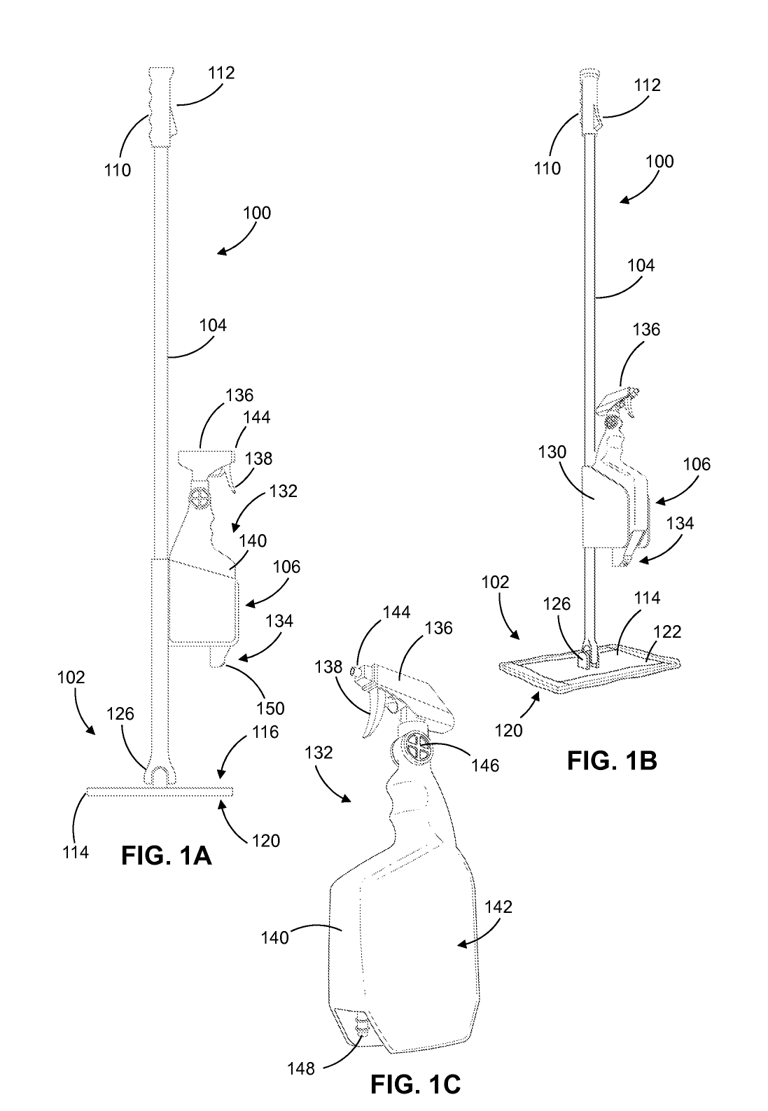

A cleaning system 100 according to at least one embodiment within the scope of these descriptions is illustrated in FIGS. 1A-1C. The cleaning system 100 includes a mopping implement 102 attached to the distal end of a pole 104. The pole 104 carries the mopping implement 102 as the proximal end of the pole is manipulated by a user going about, for example, mopping, wiping and other cleaning activities. A multi-functional dispensing apparatus 106 is mounted to the pole 104 intermediate the proximal and distal ends. A handle 110 attached to the proximal end of the pole 104 facilitates gripping and control of the cleaning system 100 overall and includes a trigger assembly 112 for controlling the dispensing apparatus 106 and optionally other functions of the cleaning system 100.

The mopping implement 102 is represented as a flat mop in the illustrated embodiment of FIGS. 1-3. The flat mop includes a flat base 114 having first and second sides that may be nominally referred to, respectively, as and upper side 116 and a lower side 120, for example when the lower side 120 is directed toward a floor to be cleaned. A replaceable microfiber pad, towel, or other absorbent cleaning or other mopping article 122 (FIG. 1B) is likely removably attached to the lower side 120 of the base 114 when in use according to preferences and uses by various users. Fixing elements such as grommets, hook or loop pads, or other retainers may be included on the base 114 for removably attaching such cleaning or mopping articles to the base. A mounting structure 126 such as a yoke is attached to the upper side 116 of the base 114 for connecting the distal end of the pole 104 to the base. The mounting structure 126 permits angular movement of the pole 104 relative to the base 114 to permit movement of the base along a floor or wall from various user positions. The mounting structure 126 may be releasable to permit separation of the pole 104 and base 114 for cleaning, storage, or maintenance.

The multi-functional dispensing apparatus 106 includes a cradle 130 mounted to the pole 104 intermediate the proximal and distal ends of the pole, a separable spray bottle 132 that docks with the cradle 130, and a mounted dispensing device 134 built into the cradle 130. The spray bottle 132 can be carried by the cradle 130 or separated for use independent of other elements of the cleaning system 100. The spray bottle 132 includes a hand-held spray head 136, a container housing 140 defining an internal reservoir 142 (FIG. 1C) for storing a cleaning solution or other liquid to be dispensed from both the hand-held spray head 136 and the mounted dispensing device 134. The spray bottle 132 includes a forward lower valved outlet port 138 for docking with a corresponding inlet valve or port built as part of the cradle 130. The valved outlet port 138 is shrouded by or recessed into partially surrounding portions of the container housing 140 to protect the valved port from damage and to prevent unwanted liquid discharge by accidental contact. The cradle 130 is shaped to accommodate and retain the outer form of the spray bottle 132 as the cleaning system 100 is used in mopping fashion.

Upon dismounting of the separable spray bottle 132 from the cradle 130, the separable spray bottle can be used by grasping the hand-held spray head 136 and pulling a trigger 138 that actuates an internal pumping mechanism which draws liquid from the internal reservoir 142 through a straw or other fluid conduit and causes dispensation of the drawn liquid through a nozzle 144 of the hand-held spray head. The internal reservoir 142 can be refilled by removing the hand-held spray head 136 from the container housing 140 and filling the internal reservoir through an upper neck of the container housing. The hand-held spray head 136 is mounted to the container housing 140, for example, by a threaded collar 146 or other releasable sealing structure. In the illustrated embodiment, the hand-held spray head 136 includes a hinging junction between the collar and trigger 138 to permit hinging of the trigger and nozzle relative to the container housing 140.

Upon mounting of the separable spray bottle in the cradle 130, the lower valved port 138 built into the container housing 140 docks with a corresponding port built into the cradle 130 to establish fluid communication between the internal reservoir 142 of the container housing 140 and the mounted dispensing device 134. Dispensation of liquid from the internal reservoir 142 through the mounted dispensing device 134 is prompted by actuation of the trigger assembly 112 of the handle 110 attached to the proximal end of the pole 104.

Dispensation of the liquid through the mounted dispensing device 134 in at least one embodiment occurs by seepage, trickling, or squirting through one more pores defined, for example, in the lower side 120 of the base 114 of the flat mop 102. Such dispensation causes wetting of any microfiber pad or other mopping article attached to the lower side of the base. Thus, the flat mop 102 can be used to both dispense a cleaning solution through a pad or mopping article and to absorb or recollect the solution, by way of an absorbent pad or mopping article, along with dirt and other contaminants dissolved or otherwise transported by mopping action. Alternatively, dispensation of the liquid through the mounted dispensing device 134 in at least one embodiment occurs by squirting or spraying action through one more nozzles 150 extending from the cradle, for example, extending and spraying solution in a forward direction away from the pole 104.

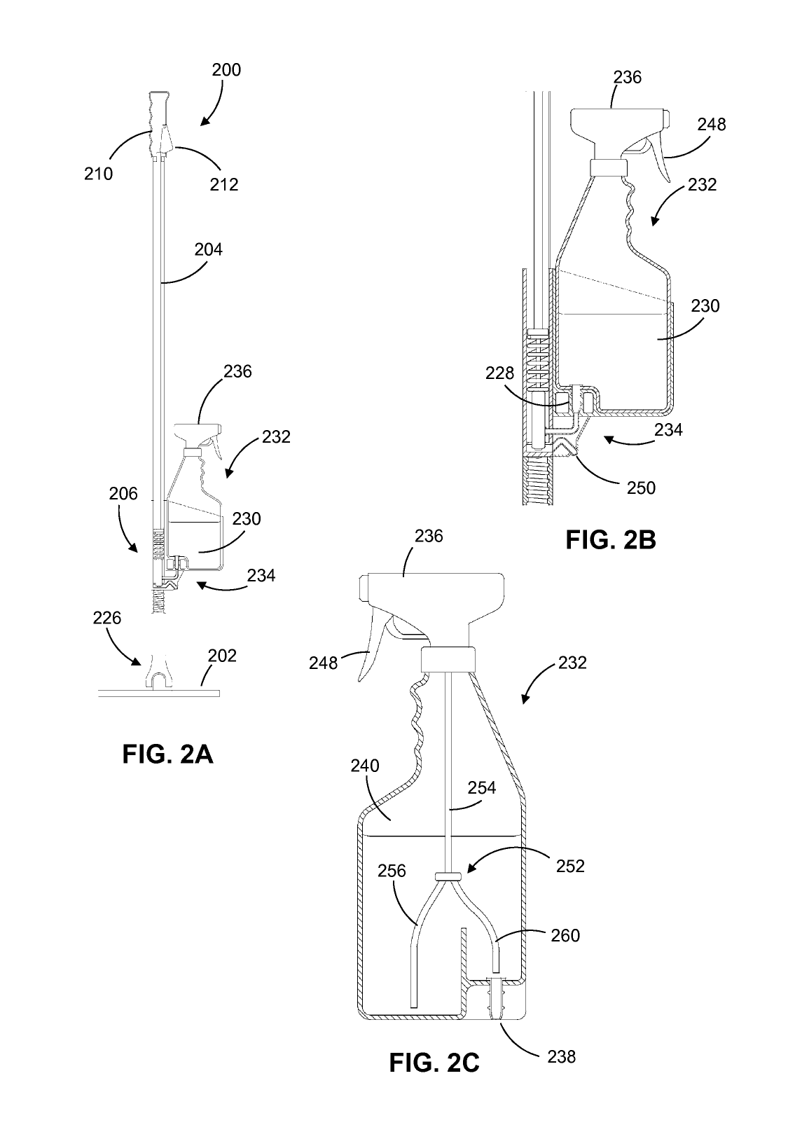

A cleaning system 200 according to at least one other embodiment within the scope of these descriptions is illustrated in FIGS. 2A-2C. The cleaning system 200 includes a mopping implement 202 attached to the distal end of a pole 204. A multi-functional dispensing apparatus 206 is mounted to the pole 204 intermediate the proximal and distal ends. A handle 210 attached to the proximal end of the pole 204 includes a trigger assembly 212 for controlling the dispensing apparatus 206.

The mopping implement 202 is represented as a flat mop while other embodiments are within the scope of these descriptions. A replaceable microfiber pad, towel, or other absorbent cleaning or other mopping article can be attached to the lower side of the mopping implement 202 when in use. The pole 204 is attached to the mopping implement 202 by a mounting structure 226 that permits angular movement of the pole 204 to permit movement along a floor or wall from various user positions. The mounting structure 226 may be releasable to permit separation of the pole 204 for cleaning, storage, or maintenance.

The multi-functional dispensing apparatus 206 includes a cradle 230 mounted to the pole 204 intermediate the proximal and distal ends of the pole, a separable spray bottle 232 that docks with the cradle 230, and a mounted dispensing device 234 built into the cradle 230. The spray bottle 232 can be carried by the cradle 230 or separated for use independent of other elements of the cleaning system 200. The spray bottle 232 includes a hand-held spray head 236, a container housing 240 defining an internal reservoir for storing a cleaning solution or other liquid to be dispensed from both the hand-held spray head 236 and the mounted dispensing device 234. The spray bottle 232 includes a rearward lower valved outlet port 238 for docking with a corresponding inlet port or valve 228 built as part of the cradle 230. The valved port 238 is protectively shrouded by or recessed into partially surrounding portions of the container housing 240.

Dispensation of solution from within the container housing 240 can occur according to either of at least two modes or configurations which may be described as mounted and dismounted modes. In the dismounted mode, the separable spray bottle 232 dismounted from the cradle 230 is used by hand independent of other elements of the cleaning system 200. The separable spray bottle can be used by grasping the hand-held spray head 236 and pulling a trigger 248. In the mounted mode, the spray bottle 232 is docked with and carried by the cradle 230 with the valved port 238 of the spray bottle mated with the inlet port or valve 228 of the cradle 230. Within the container housing 240, a bifurcated conduit assembly 252 (FIG. 2C) includes an upper tube 254 that feeds the hand-held spray head 236, for example upon a user pulling the trigger 238, a lower tube 256 by which solution is drawn from the lowest portion of the container housing 240, and a branch tube 260 by which solution is drawn from a partially walled recess formed around the valved port 238.

Dispensation of liquid from the container housing 240 through the mounted dispensing device 234 in the mounted mode is prompted by actuation of the trigger assembly 212 of the handle 210 attached to the proximal end of the pole 204. Dispensation of the liquid through the mounted dispensing device 234 in at least one embodiment occurs by seepage, trickling, or squirting through one more pores defined, for example, in the lower side of the mopping implement 202. Alternatively, dispensation of the liquid through the mounted dispensing device 234 in at least one embodiment occurs by squirting or spraying action directed forward and downward from the multi-functional dispensing apparatus 206 through one more nozzles 250 extending from the cradle. In at least one embodiment, dispensation through the mopping element 202 and dispensation through the nozzle 250 are selectively and independently controlled by independent triggers and user actions at the handle 210. In the illustrated embodiment, a nozzle 250 (FIG. 2B) is mounted above and spaced from the mounting structure 226 (FIG. 2A) and mopping implement 202, with the nozzle 250 positioned above the mopping element when in use, for example, mopping a floor. In this advantageous position of the nozzle 250, a user may direct dispensation from the nozzle 250 as desired by pivoting of the pole 204 about the mounting structure 226.

In a particular exemplary embodiment, operation for dispensing of a cleaning chemical onto a floor entails manually pressing a trigger of the trigger assembly 212, which pushes a rod within the pole 204. The rod travels linearly within the pole 204 to squeeze a compression spring and operate a small mechanical pump, which in turn pulls liquid from the spray bottle 232 and out through an orifice or nozzle 250 to get to the floor. The trigger is returned to its rest position by natural expansion of the compression spring once manual pressure is relieved at the trigger. In that or other examples, the spray bottle is placed and captured in such a way that a mechanical connection is made between a trigger mechanism provided in the floor cleaning apparatus and the trigger of the spray bottle. When the spray bottle is in place, the user is able to operate a trigger mechanism that, in turn operates the trigger of the spray bottle, thereby spraying the floor. The mechanical engagement would be such that the bottle can be removed and inserted repeatedly and make automatic engagement between the floor cleaning apparatus and the spray bottle without further user manipulation.

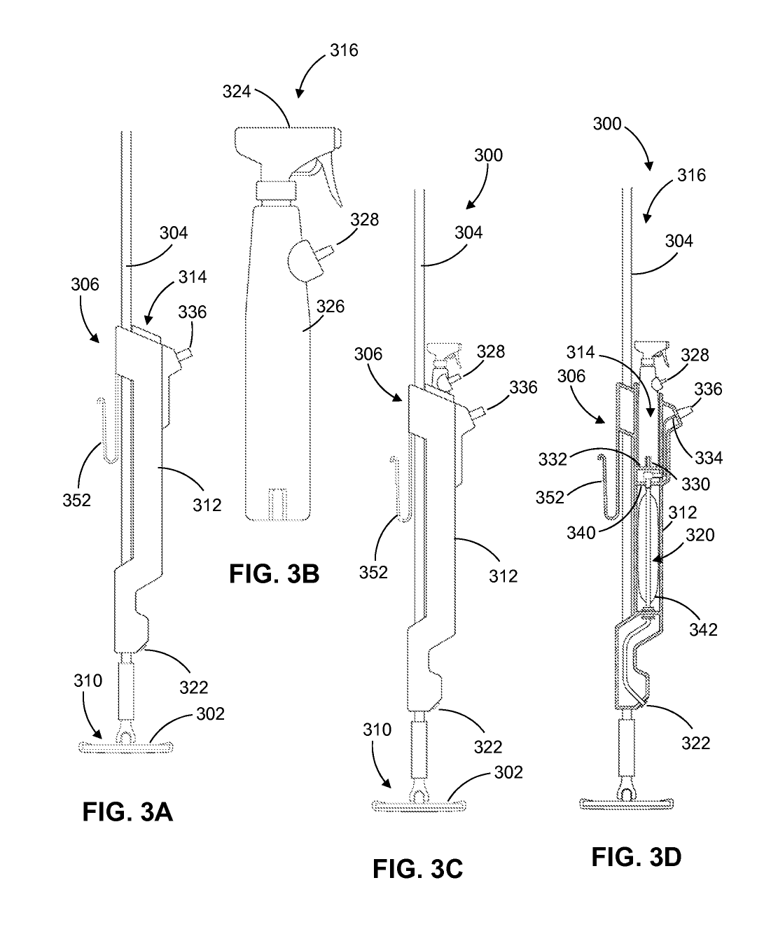

A cleaning system 300 according to at least one other embodiment within the scope of these descriptions is illustrated in FIGS. 3A-3D. The cleaning system 300 includes a mopping implement 302 and a slender multi-functional fluid storage and dispensing apparatus 306 mounted on or integral with a pole 304. The mopping implement 302 is represented as a flat mop while other embodiments are within the scope of these descriptions. A replaceable microfiber pad, towel, or other absorbent cleaning or mopping article can be attached to the lower side of the mopping implement 302 when in use. The distal end of the pole 304 is attached to the mopping implement 302 by a mounting structure 310 that permits angular movement of the pole 304 to accommodate travel along a floor, wall or other surface to be cleaned from various user positions. The mounting structure 310 may be releasable to permit separation of the pole 304 for cleaning, storage, or maintenance.

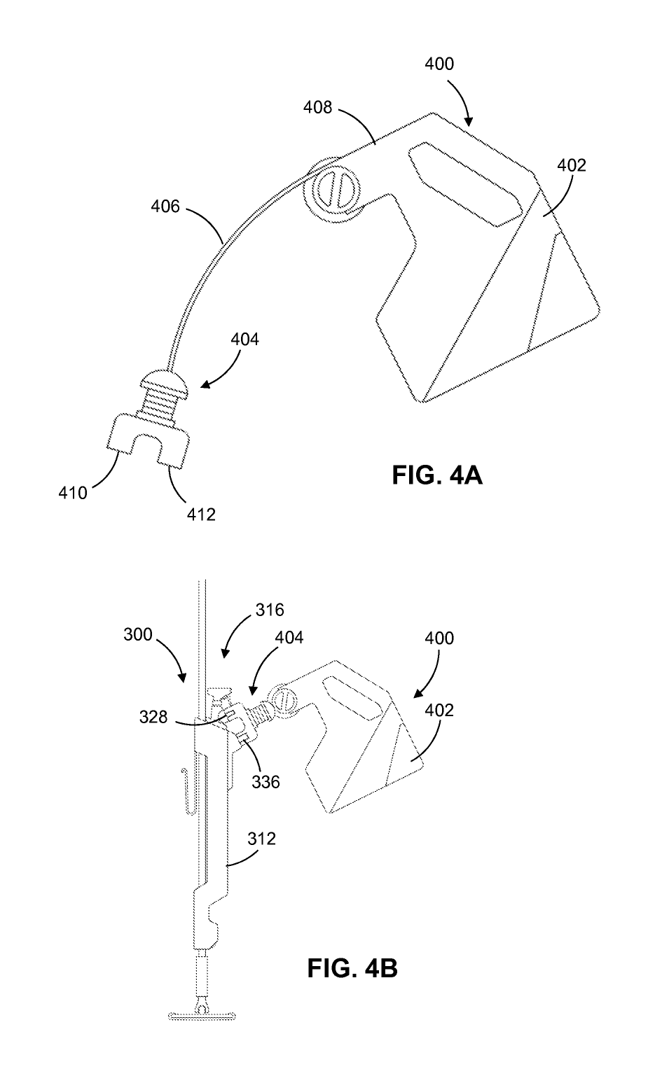

In this embodiment, the mounted storage and dispensing apparatus 306 includes a major housing 312 that defines a receptacle 314 and an internal on-board reservoir 320. The receptacle 314 serves as a cradle that carries a separable and independently useable spray bottle 316. The mounted storage and dispensing apparatus 306 also includes an on-board dispensation nozzle 322 for dispensing cleaning solution or other liquid from the on-board reservoir 320. The spray bottle 316 includes a hand-held spray head 324 and a columnar container 326 for storing a cleaning solution or other liquid to be dispensed from the hand-held spray head 324. The spray bottle 316 includes a central lower port or valve 330 for docking with a corresponding inlet port or valve 332 of the major housing 312 positioned within the lower end of the receptacle 314. The valved port 330 of the spray bottle 316, which is protectively shrouded by or recessed into partially surrounding portions of the container 326, automatically mates with the inlet valve 332 of the major housing upon full insertion of the spray bottle into the receptacle 314. Upon dismounting of the separable spray bottle 316 from the receptacle 314, the separable spray bottle can be used by grasping the hand-held spray head thereof and pulling a spray head mounted trigger that actuates an internal pumping mechanism. The columnar container 326 of the spray bottle 316 can be refilled by removing the hand-held spray head from the container. The columnar container 326 of the spray bottle 316 can also be refilled, for example as shown in FIG. 4B, through the refill inlet port or valve 328 (FIGS. 3B-3D) extending forward and upward from the columnar container 326.

The storage and dispensing apparatus 306 includes a fluid handling system internal to the major housing 312. An inlet fill tube 334 (FIG. 3D) extends internally from an exterior fill port 336 of the major housing 312 for filling of the on-board reservoir 320 from an external source (for example, see FIG. 4B). A conduit junction assembly 340 joins both the inlet fill tube 334 and the inlet valve 332 to the upper end of the on-board reservoir 320. When the spray bottle 316 is carried by the receptacle 314 such that the lower valved port 330 of the spray bottle is docked with the inlet valve 332 in the bottom of the receptacle 314, the columnar container 326 of the spray bottle 316 advantageously extends the total volume of liquid available for dispensation through the on-board dispensation nozzle 322. Such features are advantageous at least, for example, by extending the range and time of use of the cleaning system 300 in floor cleaning activities before refilling is required. Linear alignment of the columnar container 326 of the spray bottle 316 with the on-board reservoir 320 advantageously provides a slender arrangement for nimble use of the cleaning system 300 in spaces crowded by people, furniture, appliances and other structures. Storage of the cleaning system by hanging or standing in a small space such as a closet or a vehicle is also facilitated by the linear alignment. The columnar form of the spray bottle 316 fits within a columnar space above the major housing 312 to advantageously avoid widening the cleaning system 300 overall while increasing the total fluid storage capacity. Vertical alignment of the columnar container 326 of the spray bottle 316 with the on-board reservoir 320 advantageously facilitates downward fluid flow and pressurization when in use.

In at least one embodiment (FIG. 3D), liquid is stored in the internal lumen of an expandable bag or bladder 342 within a rigid chamber defined by the major housing 312. In that example, the storage capacity of on-board reservoir 320 is defined by the expandable bladder 342. Furthermore, the expandable bladder 342 in at least one example is constructed of elastomeric material like a balloon. In at least that example, continuous fluid pressure is maintained by the bladder 342 across a range of stored liquid volume. Furthermore, refilling of the storage and dispensing apparatus 306 may be accomplished by simply installing a full replaceable bag into the rigid chamber of the major housing.

The storage and dispensing apparatus 306 can also be refilled, for example as shown in FIG. 4B, through the exterior fill port 336 (FIGS. 3A and 3C-3D) that extends forward and upward from the major housing 312 below the refill inlet valve 328 of the spray bottle 316. Upon full insertion of the spray bottle 316 into the receptacle 314 (FIGS. 3C-3D), the refill inlet valve 328 of the spray bottle 316 and the exterior fill port 336 of the major housing 312 are advantageously positioned and oriented in relation to each other for simultaneous docking with respective couplings of a refilling head 404 as shown in FIG. 4B.

Dispensation of liquid from the on-board reservoir 320 through the dispensing apparatus 306 mounted on or integral with a pole 304 is prompted by actuation of the trigger assembly of a handle, for example as illustrated in the other drawings, attached to a proximal end of the pole 304 opposite the distal end of the pole 304 and the mopping implement 302. Dispensation of the liquid through the mounted dispensing device 306 in at least one embodiment occurs by seepage, trickling, or squirting through one more pores defined, for example, in the lower side of the mopping implement 302. In the illustrated embodiment, dispensation of the liquid through the mounted dispensing device 306 occurs by squirting or spraying action directed forward and downward from the mounted dispensing apparatus through one more nozzles 322 extending from the major housing. In at least one embodiment, dispensation through the mopping element 302 and dispensation through the nozzle 322 are selectively and independently controlled by independent triggers and user actions at a handle attached to the pole 304. A hooked hanger 352 extends from the major housing 312 to receive and carry a cleaning cloth or other tools or implements for carrying convenience.

A refilling assembly 400 for use in filling both the spray bottle 316 and the on-board reservoir 320 is illustrated in FIGS. 4A-4B. The refilling assembly includes a voluminous tank 402 and a refilling head 404 that deploys from the tank on a flexible conduit 406. The conduit 406 can be extended from the tank 402 for deployment and far use of the refilling head 404 as shown in FIG. 4A. The conduit 406 can be withdrawn into the tank 402 and the refilling head 404 effectively mounted to tank 402 for near use as shown in FIG. 4B. In at least one embodiment, the refilling head 404 mounts upon the neck 410 of the tank 402 with the conduit 406 internally wound about a spool turned manually by a dial or automatically by a coil spring.

The refilling head 404 includes two couplings 410 and 412 that are advantageously positioned and oriented in relation to each other for simultaneous docking with the refill inlet valve 328 of the spray bottle 316 and the exterior fill port 336 of the major housing 312 respectively. In the illustrated embodiment, the spacing between the two couplings 410 and 412 matches the spacing between the refill inlet valve 328 of the spray bottle 316 and the exterior fill port 336 of the major housing 312 when the spray bottle 316 is fully inserted into the receptacle 314 (FIGS. 3C-3D) of the major housing. Furthermore, the two couplings 410 and 412 extend parallel to each other to permit smooth simultaneous coupling with the refill inlet valve 328 and the exterior fill port 336 from a single angle of approach. The refilling assembly 400 provides for safe and clean filling operations keeping chemicals from spilling and getting on a user.

The two couplings 410 and 412 may have different sized outlets or orifices to provide balanced amounts of solution by delivering different filling rates for the spray bottle 316 and on-board reservoir 320 to facilitate complete fillings (from empty) at approximately the same time. For example, a smaller outlet or orifice may be preferred for the coupling 410 corresponding to a smaller storage capacity of the spray bottle 316 relative to the on-board reservoir 320. In such an example, the columnar container 326 of the the spray bottle 316 and on-board reservoir 320 may receive the same solution in different amounts and the conduit 406 can be a single lumen tube in fluid communication with a single storage chamber defined by the tank 402. Furthermore, the spray bottle 316 and on-board reservoir 320 may contain different solutions, for example a neutral cleaning agent and a disinfectant respectively. In such an example, the conduit 406 can be a dual lumen tubing structure providing separate fluid communication to two separate storage chambers defined by the tank 402. In such an example, where solutions in the columnar container 326 of the spray bottle 316 and the on-board reservoir 320 are to be unmixed, the lower valved port 330 of the spray bottle and the inlet valve 332 in the bottom of the receptacle 314 may be maintained in closed configurations.

By providing spray bottles separable from their mounted positions on mop handle structures, the embodiments described above serve a wide range of cleaning uses. For commercial or home use, fewer tools and chemicals can be carried, for example on a janitor's cart. Space is saved and carried loads are lightened. Less items overall are carried into a room to clean. A mop and integrated spray bottle can be carried in one hand and paper towels or cloth in another hand. Note that an integrated spray bottle can be removed from its mounted position on a mop and used for cleaning fixtures, counter tops and other surfaces with a cleaning cloth by hand. For example, a custodian cleaning a food court in a mall may have little room to move a mop bucket and wringer or even a janitor's cart between groups of tables. By use of embodiments expressly described herein and those within the scope of these descriptions taken cumulatively, the user could carry a mop with a spray bottle to spill sites and spot cleaning locations and remove the spray bottle to clean table tops and other surfaces.

While the embodiments have been described in connection with the preferred embodiments of the various figures, it is to be understood that other similar embodiments may be used or modifications and additions may be made to the described embodiments for performing the same function without deviating therefrom. Therefore, the disclosed embodiments should not be limited to any single embodiment, but rather should be construed in breadth and scope in accordance with the appended claims.

What is claimed is:

1. A cleaning system comprising:
an elongate pole having a proximal end for manipulation by a user and a distal end opposite the proximal end;
a mounting structure attached to the distal end of the pole for connecting a mopping implement to the distal end of the pole;
a cradle attached to the pole between the proximal end and the distal end; and
a spray bottle including a spray head, an operable trigger, and a container housing defining an internal reservoir space, the container housing removably received by the cradle.

2. A cleaning system according to claim 1, further comprising a mounted dispensing device connected to the cradle, wherein:
the mounted dispensing device includes an inlet port; and
the container housing of the spray bottle includes an outlet port that mates with the inlet port of the mounted dispensing device when the spray bottle is received by the cradle.

3. A cleaning system according to claim 2, wherein the outlet port is recessed at least partially into a portion of the container housing.

4. A cleaning system according to claim 2, further comprising a second operable trigger mounted on the pole, wherein dispensation from the internal reservoir space through the mounted dispensing device is prompted by actuation of the second operable trigger.

5. A cleaning system according to claim 4, wherein dispensation from the internal reservoir space through the spray head of the spray bottle is prompted by actuation of the operable trigger of the spray bottle.

6. A cleaning system according to claim 2, wherein the mounted dispensing device comprises a nozzle spaced from the mounting structure.

7. A cleaning system according to claim 1, further comprising a flat mop connected to the mounting structure.

8. A cleaning system comprising:
an elongate pole having a proximal end for manipulation by a user and a distal end opposite the proximal end;
a mounting structure attached to the distal end of the pole for connecting a mopping implement to the distal end of the pole;
a fluid storage and dispensing apparatus mounted on an intermediate portion of the pole, the fluid storage and dispensing apparatus including a major housing having a receptacle, an internal on-board reservoir, and an on-board dispensation nozzle; and
a separable spray bottle including a spray head, a trigger, and a container removably received by the receptacle.

9. A cleaning system according to claim 8, wherein the spray bottle includes an outlet port;
the major housing includes an inlet port positioned in the receptacle; and
the outlet port of the spray bottle mates with the inlet port of the major housing upon insertion of the container into the receptacle.

10. A cleaning system according to claim 9, wherein the container of the spray bottle comprises a columnar container.

11. A cleaning system according to claim 9, wherein the outlet port of the spray bottle comprises a valved outlet port protectively shrouded by at least partially surrounding portions of the container.

12. A cleaning system according to claim 9, wherein when the outlet port of the spray bottle mates with the inlet port of the major housing upon insertion of the container into the receptacle, the container of the spray bottle extends the total volume available to the on-board dispensation nozzle to include both the internal on-board reservoir and the container of the spray bottle.

13. A cleaning system according to claim 8, wherein the container of the spray bottle and the on-board reservoir are linearly aligned when the container is received by the receptacle.

14. A cleaning system according to claim 13, wherein the container of the spray bottle has a columnar form that fits within a columnar space defined by the major housing.

15. A cleaning system according to claim 8, wherein the on-board reservoir is defined by an expandable bladder positioned within a rigid chamber defined by the major housing.

16. A cleaning system according to claim 15, wherein the expandable bladder comprises elastomeric material.

17. A cleaning system according to claim 8, wherein:
the spray bottle comprises an inlet port for filling the container of the spray bottle; and
the fluid storage and dispensing apparatus comprises an exterior fill port for filling the on-board reservoir.

18. A cleaning system according to claim 17, further comprising a refilling assembly for use in filling both the container of the spray bottle and the on-board reservoir, wherein:
the refilling assembly includes a tank and a refilling head extending from the tank; and
the refilling head includes two couplings separated by a spacing that matches a spacing between the inlet port of the spray bottle and the exterior fill port when the container of the spray bottle is inserted into the receptacle of the major housing.

19. A cleaning system according to claim 18, wherein the refilling head extends from the tank on a flexible conduit.

20. A cleaning system according to claim 18, wherein the two couplings extend parallel to each other to permit simultaneous coupling with the inlet port of the spray bottle and the exterior fill port from a single angle of approach.
